(19) United States
(12) Patent Application Publication
(10) Pub. No.: US 2003/0145126 A1
(43) Pub. Date: Jul. 31, 2003

(54) PROGRAM CONTROL THROUGH A COMMAND APPLICATION METHOD

(76) Inventor: DAVID M. WEIGHTMAN, SHORVIEW, MN (US)

Correspondence Address: COE F MILES, TROP PRUNER HU & MILES, 8554 KATY FREEWAY, SUITE 100, HOUSTON, TX, 77059

(21) Appl. No.: 09/259,621

(22) Filed: Feb. 26, 1999

(51) Int. Cl. G06F 9/00; G06F 9/46

(52) U.S. Cl. 709/320

(57) ABSTRACT

A method, operating in an unattended mode, to coordinate (in time) the control of multiple programs includes obtaining a command sequence having a plurality of commands, selecting a first command from the command sequence (the first command having an associated first target program and an first time value), issuing the first command to the first target program at a time corresponding to the first time value, selecting a second command from the command sequence (the second command having an associated second target program and an second time value), and following issuance of the first command issuing the second command to the second target program at a time corresponding to the second time value.

### RELATED APPLICATIONS

This application is related to U.S. patent application entitled “Program Control Through A Command Application Device” (attorney docket number MICE-0008-01-U.S.), filed contemporaneously.

### BACKGROUND

The invention relates generally to the control of software programs and, more particularly, to techniques for coordinating command sequences to selectively invoke, and/or command, and/or terminate software programs through an unattended command application.

Personal computer systems (PCs) have, during the past decade, evolved into widely used electronic home appliances. Increased use of PCs in the home has relied in part on the development of powerful user programs such as graphics-oriented word processing programs and internet browsers. Another aspect of the increased use of PCs in the home is their increased connectivity to, and compatibility with, other common household electronic appliances such as telephones, televisions, video recorders (VCRs), and digital video disk (DVD) and compact disk (CD) players. In the wake of this increased use, numerous separate application programs that interface to and control external peripheral devices (e.g., a VCR) have become available.

Although great strides have been made in increasing the usefulness of home PCs, certain usability problems remain. One significant usability problem is that of controlling and coordinating multiple applications from a single unattended process or application. Consider, for example, the scenario where a PC user wants to schedule a VCR control program to record a specified television program on a certain date. Such an operation requires the time-coordinated activation and control of possibly multiple software programs (each of which may control a different peripheral device such as a VCR and television). Current techniques allow a user to perform this task in real-time—while they sit at their computer system. In addition, many computer operating systems support the use of batch files to initiate some operations at a future time. Still other operating systems provide application scheduling programs. Batch files, application scheduling programs and the like, however, may require large amounts of user input to establish a time-coordinated sequence of actions.

Thus, a need exists for improved techniques to coordinate multiple software programs through an application that may run in an unattended mode.

### SUMMARY

In one embodiment the invention provides a method to coordinate (in time) the control of multiple programs via an unattended command sequence application. The method includes obtaining a command sequence having a plurality of commands, selecting a first command from the command sequence (the first command having an associated first target program and an first time value), issuing the first command to the first target program at a time corresponding to the first time value, selecting a second command from the command sequence (the second command having an associated second target program and an second time value), and following issuance of the first command issuing the second command to the second target program at a time corresponding to the second time value.

### BRIEF DESCRIPTION OF THE DRAWINGS

FIG. 1 shows a logical view of a computer system in accordance with one embodiment of the invention.

FIG. 2 shows a command sequence application method in accordance with one embodiment of the invention.

FIG. 3 shows an illustrative command sequence file.

FIGS. 4 shows a computer system in accordance with one embodiment of the invention.

### DETAILED DESCRIPTION

Techniques (including methods and devices) to coordinate the selective invocation, command, and termination of software programs through an unattended command sequence application are described. The following embodiments characterize the invention in terms of a command script interpreter and a scheduling application. These embodiments are illustrative only and are not to be considered limiting in any respect.

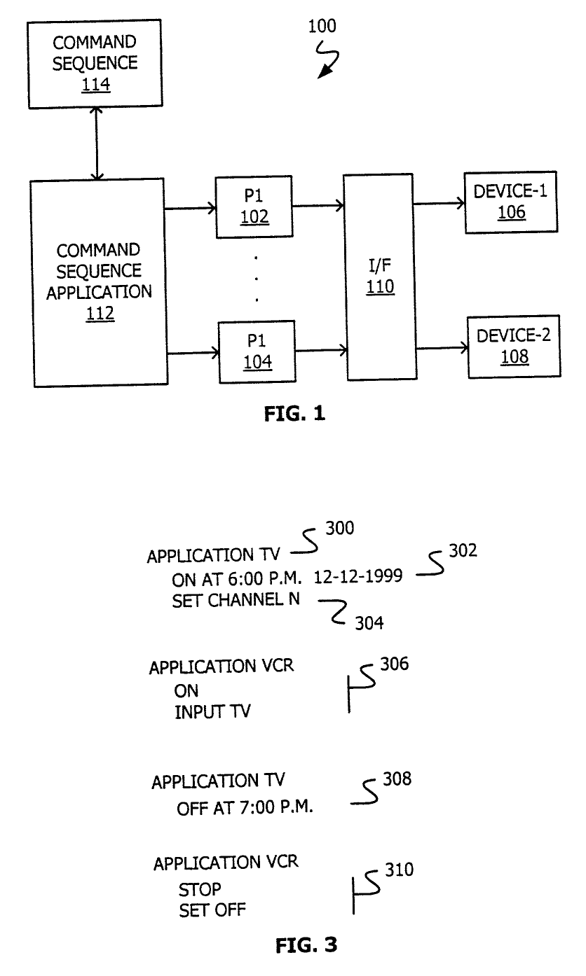

Referring to FIG. 1, a logical view of a computer system 100 in accordance with one embodiment of the invention is shown. Computer system 100 includes a plurality of user software programs (denoted P1 102 and PN 104) which control devices (e.g., devices 106 and 108) through interface 110. Illustrative software programs 102 and 104 include programs to control a computer-based telephone capability and record and play MPEG files. (MPEG—Moving Picture Experts Group—generally refers to a family of technical standards used for coding audio-visual information in a digital compressed format. MPEG standards are sponsored by the Joint International Organization for Standardization/International Engineering Consortium (ISO/IEC) Technical Committee on Information Technology.) System 100 also includes command sequence application 112 and command sequence 114. As discussed below, command sequence application 112 may issuing commands (identified in command sequence 114) to specified programs (e.g., 102 and 104) at specified times so as to coordinate and sequence the operation of the programs. Command sequence 114 may include instructions directed to a plurality of software programs. Each command may have an associated time which indicates when the command should be issued to its associated program by command sequence application 112. (A command that does not have an explicitly indicated time may, for example, be issued immediately.)

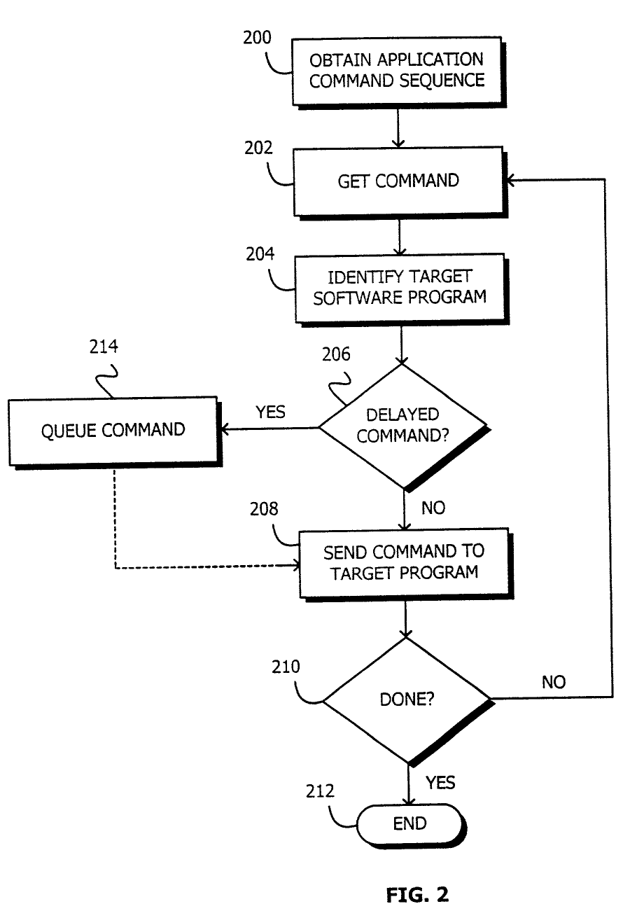

Referring to FIG. 2, a flowchart describing the operation of a command sequence application in accordance with one embodiment of the invention is shown. Initially, the command sequence application obtains a command sequence directed at one or more software programs (block 200). The application command sequence may, for example, be a script file containing one or more commands directed to one or more software programs (e.g., a television control program and/or a video recorder control program). From the obtained command sequence a first command is obtained (block 202) and, from that command, a target software program is identified (block 204).

If the obtained command does not have an associated time (the ‘no’ prong of diamond 206), the command is sent to the target software program (block 208). A command's associated time may be a specified time (e.g., 7:00 p.m. on Monday Dec. 27, 1999), a specified delay time (e.g., 5 hours and 35 minutes from now), or nothing. If no explicit time is indicated the command may be issued by the command sequence application without further delay. If the just sent command is the last command in the command sequence (the ‘yes’ prong of diamond 210), the current command sequence is complete and processing terminates (block 212). If the just sent command is not the last command in the command sequence (the ‘no’ prong of diamond 210), processing continues at block 202.

If the obtained command has an associated time (the ‘yes’ prong of diamond 206), the command and any necessary arguments may be queued for later execution (block 214). Once queued, the command sequence application may wait until the specified time to continue processing the current application command sequence. (Note, this does not preclude the command sequence application from initiating and processing another command sequence for another target software application.) In one embodiment, the command sequence application may use the System Agent application provided as part of some Microsoft Windows® operating systems to indicate when the designated time is at hand. In another embodiment, the command sequence application may initialize a counter or other timing device (hardware or software) to signal the command sequence application at the specified time. In either event, the command sequence application may suspend further processing of the current command sequence until the designated time.

Before a command sequence application can send a first command to the target software program (e.g., at block 208), a command interface or communication pipe between the two (i.e., the command sequence application and the target software program) is established. In one embodiment, the information used to establish a command interface may be hard-coded within the command sequence application itself. That is, the command sequence application may be designed explicitly to incorporate a list of software programs, the type of command interfaces they support, and their command sequences. In another embodiment, the command sequence application may be designed to query specific applications at run-time to determine which standard run time interfaces they support and what commands they may accept. In yet another embodiment, software applications may place information regarding their is command interface in a location accessible by the command sequence application during program installation. (For software programs designed to run under a Windows® operating system, a convenient location to store this type of information is the Windows® registry.) The latter two techniques provide a great deal of flexibility in terms of user friendliness while also allowing users to incrementally upgrade their software programs to support a command sequence application in accordance with the invention.

One command interface that may be used in the present invention is described in co-pending and commonly assigned U.S. patent application Ser. No. 09/122,518, filed Jul. 24, 1998 and entitled “Integrated Application Management System,” by David M. Weightman, Robert Williams, and Robert Hoffman. The aforementioned patent application is hereby incorporated in its entirety by reference.

In addition, embodiments of the invention may directly use remote procedure call (RPC) techniques to communicate between a command sequence application and various software programs. Alternatively, embodiments of the invention may use the Microsoft® Component Object Model (“COM”) to communicate between a command sequence application and various software programs. That is, to establish a command interface. (See “Inside OLE,” 2d edition, Kraig Brockschmidt, Microsoft Press, 1998.) Here, an interface may comprise one or more function pointers through which one process can call a function supported and executed by another process. COM also provides general function calls (e.g., QueryInterface through which one process can inquire about the interfaces supported by another process and can determine the nature of each function within each interface). Thus, COM allows a process, at run-time, to determine the exported functions provided by another running process and to call those functions. COM may also allow one process to call another process running on a remote machine. Although the currently described embodiment employs COM, other object and/or communication models supported by other vendors on other platforms may also be utilized for implementing a command interface.

Referring to FIG. 3, an example command sequence to record a one hour television program is shown. Initially, a television control program is identified by the keyword APPLICATION and TV 300 (see block 204 in FIG. 2). Command 302 indicates an ON command is to be sent to the identified television program at 6:00 p.m. on the specified date. In accordance with FIG. 2 (see block 214), the ON command is queued for execution at 6:00 p.m. on the proper date. At 6:00 p.m. the command sequence application is notified that the queued ON command may be processed. That is, the command sequence application issues an ON command to the identified television program using a command interface as described above. Following command 302, set channel command 304 is sent to the television application. Next, a video recorder (VCR) program is identified, turned on, and its input stream directed to receive input from the identified television application (commands 306). If necessary, the command sequence application will establish a command interface with the identified VCR program prior to issuing the ON command. Command 308, to turn television application off, is then queued for execution at 7:00 p.m. after which the VCR application is stopped and turned off via commands 310.

It should be noted that the command sequence of FIG. 3 is illustrative only and is not meant to mandate any specific syntax. Command sequences of the type shown in FIG. 3 may be generated using standard text processing applications. Once created, the user may execute the command sequence application and identify the command sequence file. Alternatively, command sequences may be generated through a graphical user interface using standard techniques to produce command sequences similar to that shown in FIG. 3.

As discussed above, software programs to be controlled by a command sequence application may store (during program installation, for example) identification and command information in a central location such as the Windows® registry file. For example, during the load process an application may store keys associated with each command the program is capable/willing to accept from a remote source. For example, a program may generate a registry key (associated with its Global Unique Identifier—GUID—for example) for each command it can receive. Illustrative command indications include a command name (e.g., RUN) appended to the name of the program (e.g., PROGRAM1) or its GUID registry entry. Thus, one registry entry for PROGRAM1 may be PROGRAM1:RUN. Any command arguments allowed or required may also be indicated in this same manner.

Table 1 shows examples of various software programs that may be controlled by a command sequence application in accordance with the invention. Table 2 lists some software programs and some of the commands they may accept from a command sequence application. (Note, some commands may have one or more arguments that are either required or optional. Registry entries, such as those shown in Table 2, may incorporate this information.)

TABLE 1
Example Applications

| Application | Function |
|---|---|
| Digital Video | Plays digital video disks through speakers and |
| Disk Player | monitor of a personal computer (PC). |
| Audio Player | Plays “WAV” files and other stored audio data |
| | through speakers attached to a PC. |
| Compact Disk | Plays prerecorded music compact disks through |
| Player | speakers attached to a PC. |
| MPEG Movie | Plays prerecorded MPEG movies through a MPEG |
| Player | player unit. |
| Video Capture | Records video data to PC data storage devices. |
| Television | Provides television broadcast reception and display |
| Application | of television programming on a PC. |
| Electronic | Provides a television programming schedule. |
| Program Guide | |
| Telephony | Provides audio telephone calls through a PC and |
| | attached peripherals. |
| Video | Provides both visual and audio data exchange in the |
| Telephone | context of telephone communications. |
| Web Browser | Provides navigation to, and display of, graphical |
| | Internet pages. |

TABLE 2
Example Applications and Associated Commands

| Application | Commands |
|---|---|
| DVD Player | PLAY; STOP; TERMINATE; PAUSE; MUTE; FAST- |
| | FORWARD; REWIND; SEEK; FULL-SCREEN; |
| | WINDOWED; MAXIMIZE; MINIMIZED; EJECT; NO- |
| | COMMAND |
| Audio | PLAY; STOP; PAUSE; FAST-FORWARD; REWIND; |
| Player | RECORD; NEXT-TRACK; PREVIOUS-TRACK; SEEK; |
| | NO-COMMAND |
| CD | PLAY; STOP; PAUSE; FAST-FORWARD; REWIND; |
| Player | NEXT-TRACK; PREVIOUS-TRACK; SEEK; EJECT; NO- |
| | COMMAND |
| MPEG | PLAY; STOP; PAUSE; MUTE; FAST-FORWARD; |
| Movie | REWIND; SEEK; NO-COMMAND |
| Player | |
| Video | START; STOP; PAUSE; NO-COMMAND |
| Capture | |
| Television | START; STOP; MUTE; SET-CHANNEL; CHANGE- |
| Application | CHANNEL-UP; CHANNEL; -DOWN; NO-COMMAND |
| Electronic | DELAY-NOTIFICATION; START SELECTED; |
| Program | PROGRAM; BECOME-ACTIVE-APPLICATION; NO- |
| Guide | COMMAND |
| Telephony | ANSWER-CALL; IGNORE-CALL; SEND-CALL-TO- |
| | VOICE; MAIL; FAX-ANSWER; FAX-IGNORE; NO- |
| | COMMAND |
| Voice | ANSWER; IGNORE-CALL; SEND-CALL-TO-VOICE; |
| Telephone | MAIL; NO-COMMAND |
| Web | BECOME-ACTIVE-APPLICATION; LOAD-PAGE; NO- |
| Browser | COMMAND |

In one embodiment of the invention, a command sequence application my provide a convenient method to schedule a sequence of future actions involving the coordination of multiple software programs. In a computing environment lacking a command sequence capability of the type disclosed herein, a user may be unable to specify a coordinated sequence of commands in a convenient manner. Technology, such as that embodied in Microsoft Corporation's System Agent program for example, is limited to scheduling actions that can be initiated via a single command-line command and do not provide a mechanism to postpone some (non-timed) commands based on the completion of yet other commands, e.g., delay execution of commands 306 in FIG. 3 until the specified television application is ON and set to the correct channel (commands 300 through 304). The same failure to provide a causal connection between a first command's completion and the initiation of a second command, limits the applicability of standard batch processing techniques to the coordinated control of multiple programs.

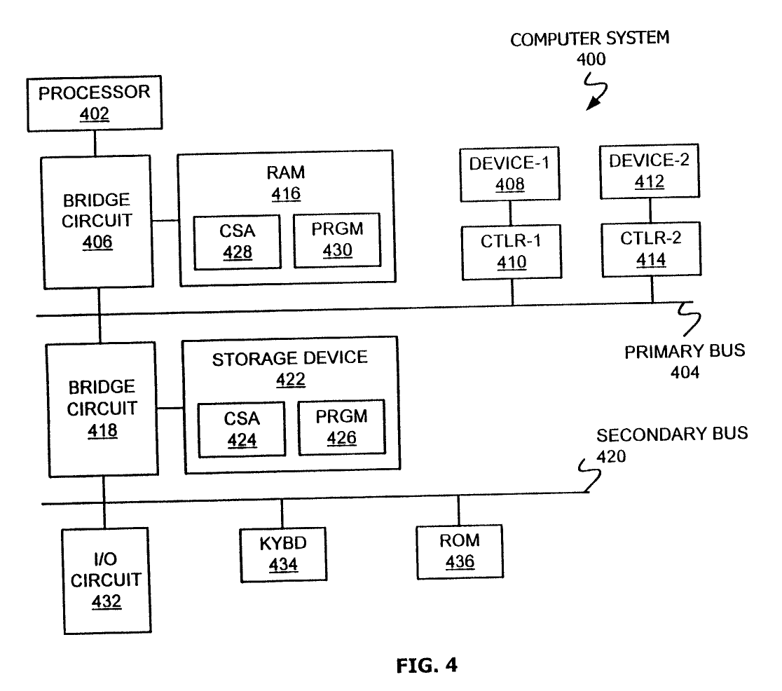

Referring now to FIG. 4, a computer system 400 providing a command sequence capability to coordinate the invocation and/or command and/or termination of one or more software programs is shown. Computer system 400 includes processor 402 coupled to primary bus 404 through bridge circuit 406. Primary bus 404 may also provide a mechanism to couple bus devices 408 and 412 (via device controllers 410 and 414) to computer system 400. Bridge circuit 406 may also provide an interface to system random access memory (RAM) 416. Processor 402 may be a general purpose processor such as a microprocessor, or a special purpose processor such as a digital signal processor or microcontroller. An illustrative primary bus may conform to the Peripheral Component Interface (PCI) bus standard. (See the “PCI Local Bus Specification, revision 2.1,” available from the PCI Special Interest Group of Hillsboro, Oreg.). Illustrative devices 408 and 412 include, but are not limited to, VCR units and televisions.

Bridge circuit 418 may couple primary bus 404 to secondary bus 420, while also providing an interface to storage device 422. Illustrative storage devices (e.g., 422) include long-term storage devices such as magnetic hard disks (fixed, floppy, and removable), magnetic tape, and optical disk units. Storage device 422 may contain a stored copy of command sequence application 424 and one or more application programs (only one shown, 426). Prior to execution of command sequence application 424, processor 402 may load a copy of command sequence application 424 into RAM 416 (thereinafter denoted as element 428). During execution of command sequence application 428, command sequence application 428 may cause stored application program 426 to be loaded into RAM 416 (thereinafter denoted as 430). Once loaded into RAM 416, command sequence application 428 may establish a command interface and issue commands to program 430.

Secondary bus 412 may also couple input-output (I/O) circuit 432, keyboard controller (KYBD) 434, and system read only memory (ROM) 436 to system 400. Input-output circuit 432, in turn, may provide electrical interfaces for parallel and serial ports, floppy disks, and infrared devices. Illustrative secondary buses include buses conforming to the Industry Standard Architecture (ISA) and Extended Industry Standard Architecture (EISA) specifications.

While the invention has been disclosed with respect to a limited number of embodiments, numerous modifications and variations will be appreciated by those skilled in the art. It is intended, therefore, that the following claims cover all such modifications and variations that may fall within the true sprit and scope of the invention. For example, a command sequence application may be implemented to execute on a number of different hardware platforms and under a variety of different operating systems. In addition, run-time error checking may be performed on some or all of the commands in the identified command sequence. Thus, prior to issuing a command to a target program (see block 208 in FIG. 2), the command sequence application may determine if (1) the target program exists, and (2) if the target program supports the intended command. To accomplish the first task, for example, the command sequence application may search local long-term storage (e.g., a magnetic hard disk) to determine if the specified target program exists. Alternatively, the command sequence application may search the Windows® registry to determine if the target program has been loaded onto the system (e.g., computer system 400). To accomplish the second task, the command sequence application may search the Windows® registry to determine if the target program supports the specified command (see Table 2 above). Alternatively, the command sequence application may query the target program (e.g., through the use of COM function calls) to determine its command interface specifics.

It will also be understood that command sequence applications in accordance with the invention may detect and log error events. For instance, if a specified command is not supported by a target program, or the target program does not exist, the command sequence application may note such an error by generating an entry into an error log.

Further, acts in accordance with FIG. 2 may be performed by a programmable control device executing instructions organized into a program module (e.g., elements 424, 426, 428 and 430 in FIG. 4). A programmable control device may be a single computer processor (e.g., 402), a plurality of computer processors coupled by a communications link, or a custom designed state machine. Custom designed state machines may be embodied in a hardware device such as a printed circuit boards comprising discrete logic, integrated circuits, specially designed application specific integrated circuits, or field programmable gate array devices. Storage devices suitable for tangibly embodying program instructions include all forms of non-volatile memory including, but not limited to: semiconductor memory devices such as electrically programmable read-only memory (EPROM), electrically erasable and programmable read-only memory (EEPROM), and flash devices; magnetic disks (fixed, floppy, and removable); other magnetic media such as tape; and optical media such as CD-ROM disks.

What is claimed is:

1. A method to coordinate the control of two or more programs, comprising:
obtaining a command sequence having a plurality of commands;
selecting a first command from the command sequence, the first command having an associated first target program and an first time value;
issuing the first command to the first target program at a time corresponding to the first time value;
selecting a second command from the command sequence, the second command having an associated second target program and an second time value; and following issuance of the first command issuing the second command to the second target program at a time corresponding to the second time value.

2. The method of claim 1, wherein the act of obtaining a command sequence comprises obtaining a script file including a plurality of commands.

3. The method of claim 1, wherein the first time value corresponds to a specified time.

4. The method of claim 3, wherein the first time value further comprises a first date value.

5. The method of claim 4, wherein the act of issuing the first command comprises issuing the first command to the first target program at a time corresponding to the first time value on a day corresponding to the first date value.

6. The method of claim 1, wherein the first time value corresponds to a specified delay time.

7. The method of claim 6, wherein the specified delay time is zero.

8. The method of claim 1, wherein the second time value corresponds to a specified time.

9. The method of claim 8, wherein the second time value further comprises a second date value.

10. The method of claim 9, wherein the act of issuing the second command comprises issuing the second command to the second target program at a time corresponding to the second time value on a day corresponding to the second date value.

11. The method of claim if wherein the second time value corresponds to a specified delay time.

12. The method of claim 11, wherein the specified delay time is zero.

13. A method to coordinate the control of two or more programs, comprising:
obtaining a command sequence having a plurality of commands, each command having an associated target program and a specified execution time;
selecting a first command from the command sequence;
delaying further processing of the command sequence until the specified execution time of the first command;
issuing the first command to the target program of the first command at the specified execution time of the first command;
selecting a second command from the command sequence;
delaying further processing of the command sequence until the specified execution time of the second command; and
issuing the second command to the target program of the second command at the specified execution time of the second command.

14. The method of claim 13, wherein the specified execution time of the first command is a specified delay time.

15. The method of claim 14, wherein the specified delay time is zero.

16. The method of claim 13, wherein the specified execution time of the first command comprises a date value and a time value.

17. The method of claim 13, wherein the specified execution time of the second command is a specified delay time.

18. The method of claim 17, wherein the specified delay time is zero.

19. The method of claim 13, wherein the specified execution time of the second command comprises a date value and a time value.
